(19) United States
(12) Patent Application Publication
(10) Pub. No.: US 2026/0276897 A1
(43) Pub. Date: Sep. 17, 2026

(54) OPTICAL CIRCUIT SWITCH (OCS) WITH MULTIPLEXED STRUCTURE

(71) Applicant: II-VI Delaware, Inc., Wilmington, DE (US)

(72) Inventors: Haijun Yuan, Dublin, CA (US); Lixin Wang, Fremont, CA (US); Chen Xia, San Jose, CA (US); Qingyu Li, Cupertino, CA (US); Haiji Jimmy Yuan, Cupertino, CA (US); Yajun Wang, Naperville, IL (US)

(21) Appl. No.: 19/324,866

(22) Filed: Sep. 10, 2025

Related U.S. Application Data
(60) Provisional application No. 63/770,547, filed on Mar. 12, 2025.

(51) Int. Cl. G02B 6/35; G02B 6/27

(52) U.S. Cl. CPC G02B 6/3542; G02B 6/2773; G02B 6/3512; G02B 6/3544

(57) ABSTRACT

An optical circuit switch includes a first branch, a second branch, and a polarization splitter. Each branch includes a first side and a second side. Each side includes a collimator array, a switch array and a polarization management unit. Beams carrying optical signals are led into the device through the collimator array. Each collimator serves as a port. The first side switch array of the first branch directs beams from the ports of the first side of the first branch toward the ports of the second side of the first branch. The first side polarization management unit of the first branch resets the polarization of the first beams. The polarization beam splitter receives the first beams, selectively directs ones of the first beams toward either the second side ports of the first branch or the second side ports of the second branch based on their respective polarization.

### CROSS-REFERENCE TO RELATED APPLICATIONS

The present application claims benefit of and priority to U.S. Provisional Application No. 63/770,547, filed Mar. 12, 2025, the contents of which are hereby incorporated herein by reference in their entirety.

### TECHNICAL FIELD

Aspects of the present disclosure relate to optical communications and optical circuit switches used in optical communications.

### BACKGROUND

Large-scale data centers may utilize optical circuit systems that include, among other things, optical circuit switches for routing optical signals through optical channels, such as optical fibers and/or waveguides. Such optical circuit switches may selectively switch optical signals between optical fibers and/or waveguides of the optical circuit systems. In particular, these optical circuit switches may switch optical signals directly rather than converting the optical signals to an intermediate electrical signal. To this end, these optical circuit switches may incorporate various optical switch elements, such as tunable mirrors, prisms, fiber collimators, and drive mechanisms, to route optical signals through the optical circuit switch.

Some optical circuit switches are based on a micro-electromechanical (MEM) devices, in which components of the optical circuit switch are manipulated by MEMs devices to route the optical signal through the optical circuit switch. Other optical circuit switches are based on liquid crystal (LC) devices, which route optical signals through the optical circuit switch. These technologies use free space optics, in which the optical signal is removed from the optical fiber or waveguide, manipulated using unguided optical components, and then reinserted into an output optical fiber or waveguide.

Increasing the number of ports of an optical circuit switch may introduce various issues. For example, an increase in the number of ports may increase the physical size of the optical fiber array. Further, an increase in the number of ports may increase the number of components used to implement the optical circuit switch and/or the cost of implementing the optical circuit switch. Additionally, an increase in the number of ports may increase a switching angle between ports beyond what is feasible or practical.

Further limitations and disadvantages of conventional and traditional approaches will become apparent to one of skill in the art, through comparison of such approaches with some aspects of the present disclosure as set forth in the remainder of the present application with reference to the drawings.

### BRIEF SUMMARY OF THE DISCLOSURE

Shown in and/or described in connection with at least one of the figures, and set forth more completely in the claims, are optical circuit systems and/or optical circuit switches which utilize polarization beam splitting and multiplexed branches to increase the number of ports serviceable by the optical circuit switch.

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts an embodiment of an optical circuit switch (OCS) in accordance with various aspects of the present disclosure.

FIG. 2 depicts an OCS branch of the optical circuit switch shown in FIG. 1.

FIG. 3 depicts another embodiment of an optical circuit switch (OCS) in accordance with various aspects of the present disclosure.

FIG. 4 depicts yet another embodiment of an optical circuit switch (OCS) in accordance with various aspects of the present disclosure.

### DESCRIPTION

The present disclosure is directed to optical circuit switches (OCS) and techniques for coupling optical ports in a reconfigurable manner. In general, the optical circuit switches (OCS) switch or direct a beam from an optical port and associated optical fiber at a first side of the optical circuit switch (OCS) to any optical port and associated optical fiber at a second side of the optical circuit switch (OCS). Desirably, the optical circuit switches (OCS) provide stable and reliable optical connections for transmission of optical signals between first side optical ports and associated optical fibers and second side optical ports and associated optical fibers. Further, the optical circuit switches (OCS) may provide bi-directional transmission in which optical signals may be transmitted from the first side to the second side, and vice versa.

In some embodiments, the optical circuit switches (OCS) may provide optical circuit switching functionality. As described in further detail herein, an optical circuit switch may selectively couple any of its first side ports to any of its second side ports. To this end, the optical circuit switches may include a first OCS branch and a second OCS branch. Each side of each OCS branch may include ports, a collimator array, an optical fiber array, and an optical switch array. Each OCS branch may effectively couple any first side port to any second side port so as to permit bidirectional optical transmission between such connected ports. An optical circuit switch (OCS) may further include polarization management units configured to selectively polarize beams of each OCS branch and a polarization beam splitter configured to selectively direct beams between OCS branches based on their polarizations. In this manner, the polarization management units and polarization beam splitter may effectively couple any first side port of the first OCS branch and the second OCS branch to any second side port of the first OCS branch and the second OCS branch.

Examples of switching blocks and polarization blocks, which may be adapted for use with the present optical circuit switch (OCS) are described in U.S. application Ser. No. 18/654,597 entitled “Optical Circuit Switch And Beam Processing Method,” filed May 3, 2024, which is incorporated herein by reference in its entirety. Other switching block and/or polarization blocks may also be used for the optical circuit switches within the scope of the present disclosure.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Also, any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

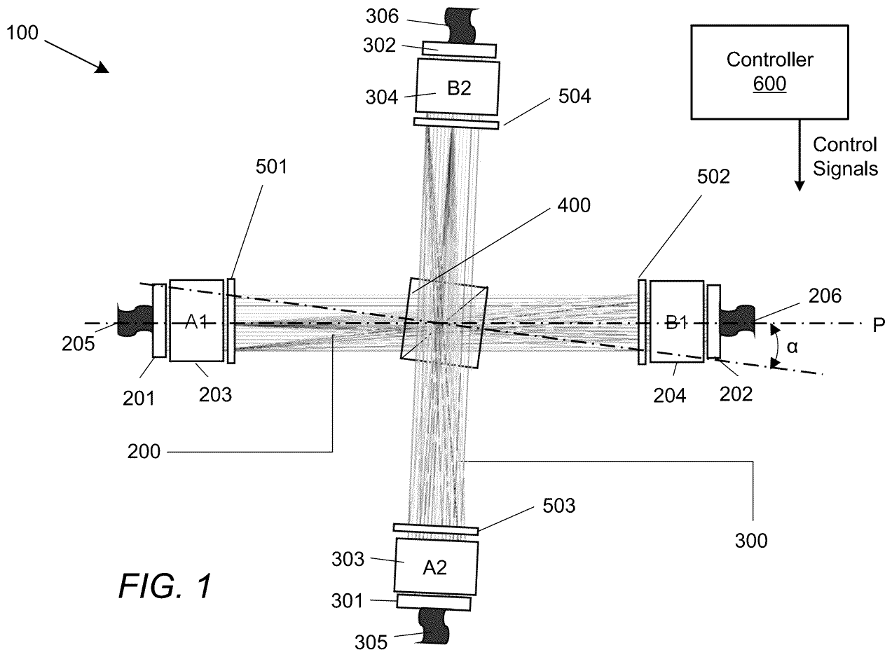

As shown in FIG. 1, an optical circuit switch (OCS) 100, in accordance with various aspects of the present disclosure, may comprise a first OCS branch 200, a second OCS branch 300, a polarization beam splitter (PBS) 400, and polarization management (PM) units 501, 502, 503, 504. The optical circuit switch (OCS) 100 may further include a controller 600 configured to generate one or more electrical control signals that control the switching of the first OCS branch 200 and the second OCS branch 300. The controller 600 may comprise processors, application specific integrated circuits (ASICs), digital circuitry, analog circuitry, software, and/or firmware which control operation of the first OCS branch 200 and the second OCS branch 300 through one or more control signals provided to the first OCS branch 200 and the second OCS branch 300 via electrical connections. Such electrical connections are not shown so as to not obscure other components of the optical circuit switch (OCS) 100. Moreover, while depicted as part of the optical circuit switch (OCS) 100, one or more portions of the controller 600 may be provided by processors, ASICs, digital circuitry, analog circuitry, software, and/or firmware of components external to the optical circuit switch (OCS) 100.

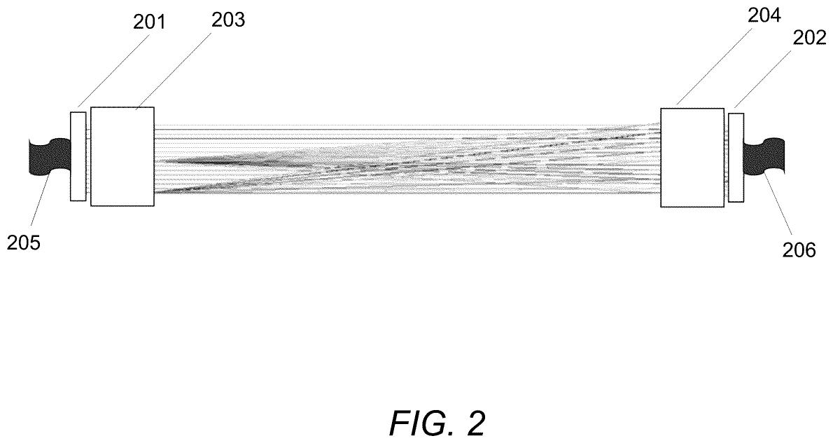

The first OCS branch 200 is shown in FIG. 2 separated from the other OCS branch 300, the polarization beam splitter (PBS) 400, and the polarization management (PM) units 501, 502, 503, 504 of FIG. 1. The OCS branch 300 may be implemented in a similar manner.

The first OCS branch 200 may comprise N ports at a first OCS branch first side A1 and N ports at a first OCS branch second side B1, wherein N is a positive integer. The first OCS branch 200 may direct beams between any port of the first OCS branch first side A1 and any port of the first OCS branch second side B1, effectively coupling any port of the first OCS branch first side A1 to any port of the first OCS branch second side B1. Moreover, the first OCS branch 200 may direct beams so as to provide bidirectional transmission between coupled ports of the first OCS branch first side A1 and the first OCS branch second side B1. In particular, the first OCS branch 200 may provide N! (i.e., N factorial) connection options between its ports. Moreover, controller 600 may generate one or more control signals via its electronics and/or software that configure which connection option of the N! connection options that the ports of the first OCS branch first side A1 are coupled to the ports of the first OCS branch second side B1.

Similarly, the second OCS branch 300 may comprise N ports at a second OCS branch first side A2 and N ports at a second OCS branch second side B2. The second OCS branch 300 may direct beams between any port of the second OCS branch first side A2 and any port of the second OCS branch second side B2, effectively coupling any port of the second OCS branch first side A2 to any port of the second OCS branch second side B2. Moreover, the second OCS branch 300 may direct beams so as to provide bidirectional transmission between ports of the second OCS branch first side A2 and the second OCS branch second side B2. In particular, the second OCS branch 300 may provide N! (i.e., N factorial) connection options between its ports. Moreover, the controller 600 may generate one or more control signals via its electronics and/or software that configure which connection option of the N! connection options is provided by the second OCS branch.

The polarization beam splitter (PBS) 400 may be positioned at an intersection of the first branch 200 and the second branch 300 so as to selectively reflect beams from ports of the first OCS branch first side A1 to ports of the second OCS branch second side B2 and selectively reflect beams from ports of the second OCS branch second side B2 to ports of the first OCS branch first side A1. In this manner, the polarization beam splitter (PBS) may effectively couple ports of the first OCS branch first side A1 to ports of the second OCS branch second side B2. Similarly, the polarization beam splitter (PBS) 400 may selectively reflect beams from ports of the second OCS branch first side A2 to ports of the first OCS branch second side B1 and selectively reflect beams from ports of the first OCS branch second side B1 to ports of the second OCS branch first side A2, effectively coupling ports of the second OCS branch first side A2 to ports of the first OCS branch second side B1.

Thus, the first OCS branch 200 and the second OCS branch 300 may collectively provide 2N ports at an OCS first side A (i.e., the first OCS branch first side A1 and the second OCS branch first side A2) and collectively provide 2N ports at an OCS second side B (i.e., the first OCS branch first side A1 and the second OCS branch first side A2). Moreover, the polarization beam splitter (PBS) 400 may provide bidirectional transmission between the 2N ports of the OCS first side A and the 2N ports of the OCS second side B. In particular, the optical circuit switch (OCS) 100 may provide (2N)! (i.e., 2N factorial) reconfigurable connection options between its ports.

To this end, each side of each OCS branch 200, 300 may include a collimator array 201, 202, 301, 302, an optical switch array 203, 204, 303, 304, and an optical fiber array 205, 206, 305, 306. Each optical fiber array 205, 206, 305, 306 may comprise N optical fibers and associated ports, each optical switch array 203, 204, 303, 304 may comprise N optical switches, and each collimator array 201, 202, 301, 302 may comprise N collimators. Each collimator array 201, 202, 301, 302 may collimate and direct beams between the N optical fibers of its respective optical fiber array 205, 206, 305, 306 and the N optical switches of its respective optical switch array 203, 204, 303, 304. In particular, each collimator array 201, 202, 301, 302 may form a series of parallel beams with a designed vertical pitch and a designed horizontal pitch that matches a designed vertical pitch and a designed horizontal pitch between optical switches of its respective optical switch array 203, 204, 303, 304. Each collimator array 201, 202, 301, 302 may collimate each beam of its optical fiber array 205, 206, 305, 306 to allow enough working distance for the optical circuit switch (OCS) 100 to route and provide good coupling efficiency between ports of the OCS first side A and the OCS second side B.

Each optical switch array 203, 204, 303, 304 may comprise N micro electro-mechanical systems (MEMS) switches, N Digital Liquid Crystal (DLC) switches, or N other optical switches. Each collimator array 201, 202, 301, 302 may collimate and direct each beam from a respective optical fiber to a respective optical switch.

In particular, each optical switch of the optical switch array 203 at the first OCS branch first side A1 may angularly switch a beam from the first side A1 in one of N directions and direct the beam from the first side A1 to a respective one of the N optical switches of the optical switch array 204 at the first OCS branch second side B1. Each optical switch of the optical switch array 204 at the first OCS branch second side B1 may direct the beam to its respective collimator of the collimator array 202 at the first OCS branch second side B1. The respective collimator of the collimator array 202 at the first OCS branch second side B1 may in turn collimate and direct the beam to a respective optical fiber of the optical fiber array 206 at the first OCS branch second side B1.

Conversely, each optical switch of the optical switch array 204 at the first OCS branch second side B1 may angularly switch a beam from the second side B1 in one of N directions and direct the beam from the second side B1 to a respective one of the N optical switches of the optical switch array 203 at the first OCS branch first side A1. Each optical switch of the optical switch array 203 at the first OCS branch first side A1 may direct the beam to its respective collimator of the collimator array 201 at the first OCS branch first side A1. The respective collimator of the collimator array 201 at the first OCS branch first side A1 may in turn collimate and direct the beam to a respective optical fiber of the optical fiber array 205 at the first OCS branch first side A1.

Similarly, each optical switch of the optical switch array 303 at the second OCS branch first side A2 may angularly switch a beam from the first side A2 in one of N directions and direct the beam from the first side A2 to a respective one of the N optical switches of the optical switch array 304 at the second OCS branch second side B2. Each optical switch of the optical switch array 304 at the second OCS branch second side B2 may direct the beam to its respective collimator of the collimator array 302 at the second OCS branch second side B2. The respective collimator of the collimator array 302 at the second OCS branch second side B2 may in turn collimate and direct the beam to a respective optical fiber of the optical fiber array 306 at the second OCS branch second side B2.

Conversely, each optical switch of the optical switch array 304 at the second OCS branch second side B2 may angularly switch a beam from the second side B2 in one of N directions and direct the beam from the second side B2 to a respective one of the N optical switches of the optical switch array 303 at the second OCS branch first side A2. Each optical switch of the optical switch array 303 at the second OCS branch first side A2 may direct the beam to its respective collimator of the collimator array 301 at the second OCS branch first side A2. The respective collimator of the collimator array 301 at the second OCS branch first side A2 may in turn collimate and direct the beam to a respective optical fiber of the optical fiber array 305 at the second OCS branch first side A2.

Thus, in response to one or more electrical control signals from the controller 600, each OCS branch 200, 300 via its respective collimator arrays 201, 202, 301, 302, its respective optical switch arrays 203, 204, 303, 304, and its optical fiber arrays 205, 206, 305, 306 may selectively couple any of its ports on its first side A1, A2 to any of its ports on its second side B1, B2.

Further, a polarization beam splitter (PBS) 400 and the polarization management (PM) units 501, 502, 503, 504 of the optical circuit switch (OCS) 100 couple ports across OCS branches 200, 300. In particular, the polarization management (PM) units 501, 502, 503, 504 may selectively polarize beams based on the one or more electrical control signals. The polarization beam splitter (PBS) 400 may selectively switch beams between OCS branches 200, 300 based on their respective polarization.

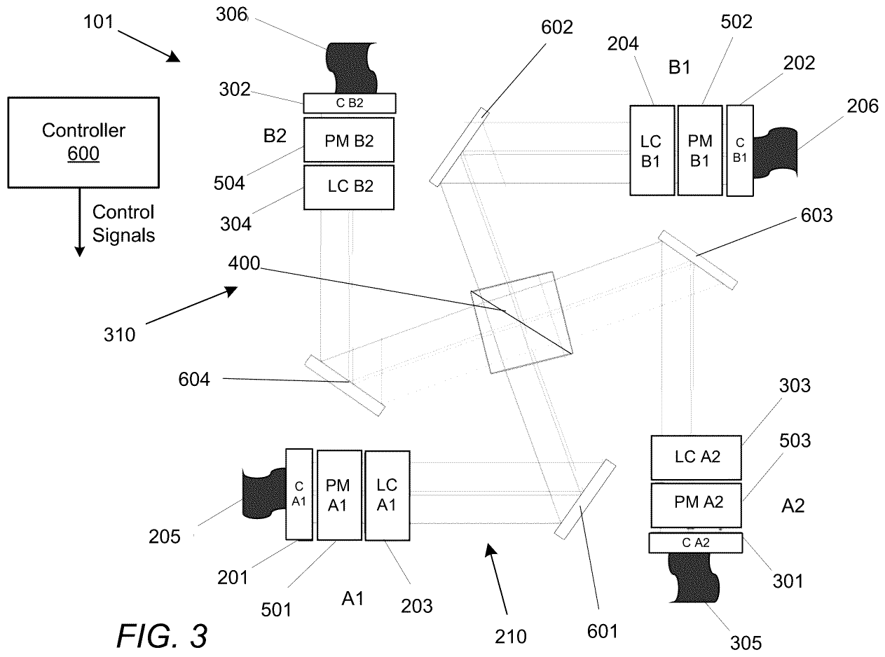

As shown in FIG. 1, the polarization management (PM) units 501, 502, 503, 504 may be positioned between the polarization beam splitter (PBS) 400 and respective optical switch arrays 203, 204, 303, 304 of the OCS branches 200, 300. However, in some embodiments, the polarization management (PM) units 501, 502, 503, 504 may be positioned between a collimator array 201, 202, 301, 302 and its respective optical switch array 203, 204, 303, 304. See, e.g., FIG. 3.

Each polarization management (PM) unit 501, 502, 503, 504 may comprise liquid crystal switches providing N independent pixels. Each pixel may selectively alter polarization of a beam passing through the respective pixel. In particular, each pixel may independently polarize its respective beam to have either a first or reflecting polarization (e.g., s-polarization) or a second or passing polarization (e.g., p-polarization) based on one or more control signals provided to the polarization management (PM) unit 501, 502, 503, 504. As explained below, the polarization beam splitter (PBS) 400 may selectively reflect beams based on their polarization. Thus, by selectively polarizing the beams, the polarization management (PM) unit 501, 502, 503, 504 may ensure that a particular beam is either transmitted through the polarization beam splitter (PBS) 400, thus remaining on the same OCS branch 200, 300, or is reflected by the polarization beam splitter (PBS) 400, thus redirecting the beam to the other OCS branch 200, 300.

Furthermore, each polarization management unit 501, 502, 503, 504 may reset the polarization of beams presented to its respective optical switch array 203, 204, 303, 304. In particular, in response to receiving a beam transmitted through the polarization beam splitter (PBS) 400, the associated pixel of polarization management unit 501, 502, 503, 504 may reset the passing polarization of the beam according to an angular adjustment needed at the respective optical switch array 203, 204, 303, 304. Conversely, in response to receiving a beam reflected by the polarization beam splitter (PBS) 400, the associated pixel of the polarization management unit 501, 502, 504, 504 may reset the reflecting polarization of the beam according to an angular adjustment needed at the respective optical switch array 203, 204, 303, 304.

The polarization beam splitter (PBS) 400 may reflect beams having a first polarization (e.g., s-polarization) and transmit beams having a second polarization (e.g. p-polarization). The first OCS branch 200 and the second OCS branch 300 may intersect such that their beams cross at an intersection or crossing point (e.g., at a midpoint of the first OCS branch 200 and at a midpoint of the second OCS branch 300). Further, the polarization beam splitter (PBS) 400 may be positioned at the intersection or crossing point so as to receive beams from both the first OCS branch 200 and the second OCS branch 300 and reflect/transmit each beam based on its polarization. In this manner, the polarization beam splitter (PBS) 400 may individually route or redirect beams between ports of the first branch first side A1 and ports of the first branch second side A2 or the second branch second side B2. Similarly, the polarization beam splitter (PBS) 400 may individually route or redirect beams between ports of the second branch first side A2 and ports of the first branch second side B1 or the second branch second side B2.

In various embodiments, the polarization beam splitter (PBS) 400 may have an angular offset α from a principle optical axis P. Such angling of the polarization beam splitter (PBS) 400 may reduce cross-talk between the first OCS branch 200 and the second OCS branch 300. Due to such angular offset α, a beam coming from the OCS first side A may hit a same pixel of a polarization management (PM) units 502, 504 at the OCS second side B at a different angle depending on whether it was transmitted or reflected by the polarization beam splitter (PBS) 400. Similarly, a beam coming from the OCS second side B may hit a same pixel of a polarization management (PM) units 501, 503 at the OCS first side A at a different angle depending on whether it was transmitted or reflected by the polarization beam splitter (PBS) 400. Such angular differentiation may ensure good isolation between transmitted and reflected beams and thus reduce cross talk between OCS branches 200, 300.

Thus, the controller 600 may select a respective destination port from the 2N ports of the OCS second side B and for each origination port of the 2N ports of the OCS first side A. Similarly, the controller 600 may select a respective destination port from the 2N ports of the OCS first side A and for each origination port of the 2N ports of the OCS second side B.

Referring now to FIG. 3, an optical circuit switch (OCS) 101, in accordance with various aspects of the present disclosure, is shown. The optical circuit switch (OCS) 101 may comprise a first OCS branch 210, a second OCS branch 310, a polarization beam splitter (PBS) 400, and polarization management (PM) units 501, 502, 503, 504. The optical circuit switch (OCS) 101 is implemented in generally the same manner as the optical circuit switch (OCS) 100 of FIG. 1. In particular, each side of the OCS branches 210, 310 may include a respective collimator array 201, 202, 301, 302, a respective optical switch array 203, 204, 303, 304, and a respective optical fiber array 205, 206, 305, 306. However, the optical circuit switch (OCS) 101 further includes mirrors 601, 602, 603, 604. Moreover, the polarization management (PM) units 501, 502, 503, 504 may be positioned between a collimator array 201, 202, 301, 302 and its respective optical switch array 203, 204, 303, 304. However, in some embodiments, the optical switch array 101 may include polarization independent switches (e.g., MEMS switches). In such embodiments, the polarization management (PM) units 501, 502, 503, 504 may be positioned between the polarization beam splitter (PBS) 400 and a respective optical switch array 203, 204, 303, 304 with a polarization switch to serve as a branch selector. See, e.g., FIG. 1. Further, the polarization beam splitter (PBS) 400 may be positioned at an intersection of the first OCS branch 210 and the second OCS branch 310 so as to route or otherwise direct beams between the first OCS branch 210 and the second OCS branch 320.

Each mirror 601, 602, 603, 604 may reflect or otherwise direct beams between the polarization beam splitter (PBS) 400 and a respective side A1, A2, B1, B2 of the OCS branches 210, 310. Such mirrors 601, 602, 603, 604 may provide greater freedom in the positioning of opposite sides of the OCS branches 210, 310. Moreover, such freedom in positioning of OCS branch first sides A1, A2 with respect to their respective OCS branch second sides B1, B2 may permit more compact arrangement of components compared to the optical circuit switch (OCS) 100 of FIG. 1.

As shown, a first side mirror 601 of the first OCS branch 210 may be positioned to direct beams from the first side A1 of the first OCS branch 210 at an upward acute angle toward the polarization beam splitter (PBS) 400. Conversely, a second side mirror 602 of the first OCS branch 210 may be positioned to direct beams from the second side B1 of the first OCS branch 210 at a downward acute angle toward the polarization beam splitter (PBS) 400. As a result of such positioning, beams may be directed between the first OCS branch first side A1 and the first OCS branch second side B1 over a branch length that is similar to the branch length of the first OCS branch 200 of FIG. 1. Such similar branch length may be obtained despite the first side A1 and the second side B1 of the first OCS branch 210 being horizontally separated by a smaller distance than the first side A1 and the second side B1 of the first OCS branch 200 of FIG. 1.

Similarly, a first side mirror 603 of the second OCS branch 310 may be positioned to direct beams from the first side A2 of the second OCS branch 310 at a leftward acute angle toward the polarization beam splitter (PBS) 400. Conversely, a second side mirror 604 of the second OCS branch 310 may be positioned to direct beams from the second side B2 of the second OCS branch 310 at a rightward acute angle toward the polarization beam splitter (PBS) 400. As a result of such positioning, beams may be directed between the second OCS branch first side A2 and the second OCS branch second side B2 over a branch length that is similar to the branch length of the second OCS branch 300 of FIG. 1. Such similar branch length may be obtained despite the first side A2 and the second side B2 of the second OCS branch 310 being vertically separated by a smaller distance than the first side A2 and the second side B2 of the first OCS branch 200 of FIG. 1. In this manner, the arrangement of the optical circuit switch (OCS) 101 may provide a vertically and horizontally more compact arrangement than the optical circuit switch (OCS) 100 of FIG. 1.

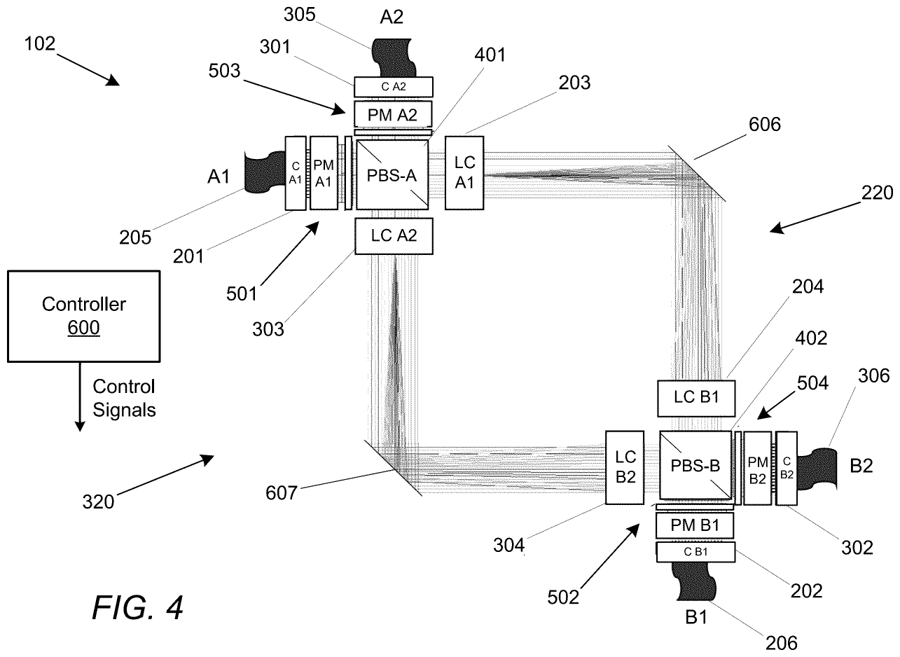

Referring now to FIG. 4, an optical circuit switch (OCS) 102, in accordance with various aspects of the present disclosure, is shown. The optical circuit switch (OCS) 102 may comprise a first OCS branch 220, a second OCS branch 320, a first side polarization beam splitter (PBS-A) 401, a second side polarization beam splitter 402, polarization management (PM) units 501, 502, 503, 504, a first branch mirror 606, and a second branch mirror 607. The optical circuit switch (OCS) 102 may be implemented in generally the same manner as the optical circuit switch (OCS) 100 of FIG. 1 and the optical circuit switch (OCS) 101 of FIG. 3. In particular, each side of the OCS branches 220, 320 may include a respective collimator array 201, 202, 301, 302, a respective optical switch array 203, 204, 303, 304, and a respective optical fiber array 205, 206, 305, 306. However, the optical circuit switch (OCS) 102 further includes branch mirrors 606, 607. Moreover, the polarization beam splitter (PBS) 400 of FIGS. 1 and 3 has been replaced with a first side polarization beam splitter (PBS-A) 401 and a second side polarization beam splitter (PBS-B) 402. Further, the first side polarization beam splitter (PBS-A) 401 may be positioned at a first side intersection of the first OCS branch 220 and the second OCS branch 320. Similarly, the second side polarization beam splitter (PBS-A) 402 may be positioned at a second side intersection of the first OCS branch 220 and the second OCS branch 320.

Similar to the optical circuit switch (OCS) 101 of FIG. 3, the polarization management (PM) units 501, 502, 503, 504 of the optical circuit switch (OCS) 102 may be positioned between a collimator array 201, 202, 301, 302 and its respective optical switch array 203, 204, 303, 304. However, unlike the optical circuit switch (OCS) 101, a first side polarization beam splitter (PBS-A) 401 is positioned between the polarization manage (PM) units 501, 503 at the first side A of the optical circuit switch (OCS) 102 and their respective optical switch array 203, 303. Similarly, a second side polarization beam splitter (PBS-B) 402 is positioned between the polarization manage (PM) units 502, 504 at the second side B of the optical circuit switch (OCS) 102 and their respective optical switch array 204, 304.

As shown, the first branch mirror 606 may be positioned between the optical switch array 203 at the first OCS branch first side A1 and the optical switch array 204 at the first OCS branch second side B1. Moreover, the first branch mirror 606 may be angled to direct beams between the optical switch arrays 203, 204. Similarly, the second branch mirror 607 may be positioned between the optical switch array 303 at the second OCS branch first side A2 and the optical switch array 304 at the second OCS branch second side B2. Moreover, the second branch mirror 607 may be angled to direct beams between the optical switch arrays 303, 304.

The optical circuit switch 101 may operate in a similar manner as the optical circuit switches 101, 102. In particular, the polarization beam splitters 401, 402 may selectively reflect beams based on their polarization so as to either redirect beams between OCS branches 220, 320 or permit beams to remain on their respective OCS branches 220, 320. However, due to the optical switch arrays 203, 204, 303, 304 being positioned after the polarization beam splitters 401, 402, the beams may remain collimated and parallel to one another as they pass through the polarization beam splitters 401, 402. This may simplify the constructions of the polarization beam splitters 401, 402 since they do not need to account for different angles due to switching, thus potentially reducing the costs of implementing such polarization beam splitters 401, 402 and/or improving the accuracy of such polarization beam splitters 401, 402.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical circuit switch, comprising:
a first branch comprising first side ports and second side ports;
a second branch comprising first side ports and second side ports; and
a first polarization beam splitter positioned at a first intersection of the first branch and the second branch;
wherein the first branch comprises a first side switch array configured to select, from the second side ports of the first branch and the second side ports of the second branch, a respective destination second side port for each origination first side port of the first side ports of the first branch, and direct each first beam from its origination first side port of the first branch along a path that leads to its respective destination second side port;
wherein the first branch comprises a first side polarization management unit configured to polarize each first beam based on whether its destination second side port is among the second side ports of the first branch or among the second side ports of the second branch; and
wherein the first polarization beam splitter is configured to direct each first beam, based on its respective polarization, toward either its destination second side port of the first branch or its destination second side port of the second branch.

2. The optical circuit switch of claim 1, comprising a controller configured to generate one or more control signals that cause the first side switch array to direct each first beam along the path that leads to its respective destination second side port.

3. The optical circuit switch of claim 1, comprising:
a controller configured to generate one or more control signals that cause the first side polarization management unit to polarize each first beam whose destination second side port is among the second side ports of the first branch with a first polarization and to polarize each first beam whose destination second side port is among the second side ports of the second branch with a second polarization; and
wherein the first polarization beam splitter is configured to direct each first beam having the first polarization toward the second side ports of the first branch and direct each first beam having the second polarization toward the second side ports of the second branch.

4. The optical circuit switch of claim 1, wherein:
the second branch comprises a first side switch array configured to select, from the second side ports of the first branch and the second side ports of the second branch, a respective destination second side port for each origination first side port of the second branch, and direct each second beam from its origination first side port of the second branch along a path that leads to its respective destination second side port;
the second branch comprises a first side polarization management unit configured to polarize each second beam based on whether its destination second side port is among the second side ports of the first branch or among the second side ports of the second branch; and
the first polarization beam splitter is configured to direct each second beam, based on its respective polarization, toward either its destination second side port of the first branch or its destination second side port of the second branch.

5. The optical circuit switch of claim 1, wherein:
the first branch comprises a second side switch array configured to select, from the first side ports of the first branch and the first side ports of the second branch, a respective destination first side port for each origination second side port of the second side ports of the first branch, and direct each second beam from its origination second side port of the first branch along a path that leads to its respective destination first side port;
the first branch comprises a second side polarization management unit configured to polarize each second beam based on whether its destination first side port is among the first side ports of the first branch or among the first side ports of the second branch; and
the first polarization beam splitter is configured to direct each second beam, based on its respective polarization, toward either its destination first side port of the first branch or its destination first side port of the second branch.

6. The optical circuit switch of claim 1, wherein the first branch comprises:
a first mirror positioned to direct each first beam from the first side ports of the first branch toward the first polarization beam splitter; and
a second mirror positioned to direct each first beam whose destination second side port is among the second side ports of the first branch from the first polarization beam splitter toward the second side ports of the first branch.

7. The optical circuit switch of claim 1, wherein the second branch comprises a first mirror positioned to direct each first beam whose destination second side port is among the second side ports of the second branch from the first polarization beam splitter toward the second side ports of the second branch.

8. The optical circuit switch of claim 1, comprising:
a second polarization beam splitter positioned at a second intersection of the first branch and the second branch; and
wherein the second polarization beam splitter is configured to direct each first beam, based on its respective polarization, toward either its destination second side port of the first branch or its destination second side port of the second branch.

9. The optical circuit switch of claim 8, wherein:
the first branch comprises a first branch mirror positioned between the first polarization beam splitter and the second polarization beam splitter and configured to direct each first beam along the first branch from the first polarization beam splitter to the second polarization beam splitter; and
the second branch comprises a second branch mirror positioned between the first polarization beam splitter and the second polarization beam splitter and configured to direct each first beam along the second branch from the first polarization beam splitter to the second polarization beam splitter.

10. The optical circuit switch of claim 9, wherein:
the first side switch array of the first branch is positioned between the first polarization beam splitter and the first branch mirror; and
the first branch comprises a second side switch array positioned between the first branch mirror and the second polarization beam splitter.

11. The optical circuit switch of claim 10, wherein:
the second branch comprises a first side switch array positioned between the first polarization beam splitter and the second branch mirror; and
the second branch comprises a second side switch array positioned between the second branch mirror and the second polarization beam splitter.

12. The optical circuit switch of claim 11, wherein:
the first branch comprises a first side collimator array between the first polarization beam splitter and the first side ports of the first branch; and
the first branch comprises a second side collimator array between the second polarization beam splitter and the second side ports of the first branch.

13. The optical circuit switch of claim 11, wherein:
the second branch comprises a first side collimator array between the first polarization beam splitter and the first side ports of the second branch; and
the second branch comprises a second side collimator array between the second polarization beam splitter and the second side ports of the second branch.

14. The optical circuit switch of claim 11, wherein:
the first branch comprises a first side fiber array associated with the first side ports; and
the first side switch array of the first branch is positioned between the first side fiber array and the first side polarization management unit of the first branch.

15. The optical circuit switch of claim 14, wherein the first branch comprises a first side collimator array between the first side fiber array and the first side switch array.

16. The optical circuit switch of claim 11, wherein:
the first branch comprises a first side fiber array associated with the first side ports; and
the first side polarization management unit is positioned between the first side fiber array and the first side switch array of the first branch.

17. The optical circuit switch of claim 16, wherein the first branch comprises a first side collimator array between the first side fiber array and the first side polarization management unit.

18. The optical circuit switch of claim 11, wherein:
the first branch comprises a first side fiber array associated with the first side ports; and
the first polarization beam splitter is positioned between the first side fiber array and the first side switch array of the first branch.

19. The optical circuit switch of claim 18, wherein the first side polarization management unit is positioned between the first side fiber array and the first polarization beam splitter.

20. The optical circuit switch of claim 19, wherein the first branch comprises a first side collimator array positioned between the first side fiber array and the first side polarization management unit.
